(19) United States
(12) Patent Application Publication
(10) Pub. No.: US 2018/0044990 A1
(43) Pub. Date: Feb. 15, 2018

(54) LADDER RAIL GRIP

(71) Applicants: Travis Smith, Bremerton, WA (US); Mike Magneson, Bremerton, WA (US)

(72) Inventors: Travis Smith, Bremerton, WA (US); Mike Magneson, Bremerton, WA (US)

(21) Appl. No.: 15/498,457

(22) Filed: Apr. 26, 2017

Related U.S. Application Data
(60) Provisional application No. 62/327,554, filed on Apr. 26, 2016.

(51) Int. Cl. E06C 7/48

(52) U.S. Cl. CPC E06C 7/48

(57) ABSTRACT

A ladder rail grip for placement over a ladder that includes: an elongated body, where the elongated body includes three sides; an opening along the length of the elongated body, where the opening is adapted for placement over a side rail of the ladder; a slot through the elongated body; a strap extending through the slot, where the strap secures the rail grip to the ladder; and a first indentation in the elongated body to accommodate a rung on the ladder. The elongated body includes a textured surface. The strap includes a buckle that slides through a slot that goes through one side of the ladder rail grip. Further, the first indentation is at a midpoint of the elongated body.

### CROSS REFERENCE TO OTHER APPLICATIONS

This application is a continuation in part to U.S. patent application Ser. No. 62/327,554 filed on Apr. 26, 2016.

### BACKGROUND OF THE INVENTION

### Field of Invention

The present invention relates to a rail grip that is placed upon a side rail of a ladder to provide support for the ladder.

### Description of Related Art

Ladders are used in various applications related to construction and general home repairs by homeowners. Ladders are used both indoors and outdoors to reach high places and typically rest against the edge of a wall or a gutter in outdoor applications. One drawback to resting a ladder against the edge of a wall or gutter is the likelihood of slipping that may occur during the use of a ladder. Should the ladder slip or shift the user could fall and have a serious injury as a result thereof. As a consequence, it would be advantageous to have a device that could be used to mount and secure the gripping of the ladder against the edge of the wall ascending and descending the ladder.

### SUMMARY OF THE INVENTION

The present invention relates to a ladder rail grip for placement over a ladder comprising: an elongated body, where the elongated body includes three sides; an opening along the length of the elongated body, where the opening is adapted for placement over a side rail of the ladder; a slot through the elongated body; a strap extending through the slot, where the strap secures the rail grip to the ladder; and a first indentation in the elongated body to accommodate a rung on the ladder. The ladder rail grip according to claim 1, where the elongated body includes a textured surface. The ladder rail grip according to claim 1, where the strap includes a buckle that slides through a slot that goes through one side of the ladder rail grip. The ladder rail grip according to claim 1, where the first indentation is at a midpoint of the elongated body.

### BRIEF DESCRIPTION OF DRAWINGS

FIG. 1 depicts a bottom view of a ladder rail grip in accordance with the present invention.

FIG. 2 depicts a sectional view of the ladder rail grip in accordance with the present invention.

FIG. 3 depicts a side view of the ladder rail grip in accordance with the present invention.

FIG. 4 depicts a top view of the ladder rail grip in accordance with the present invention.

FIG. 5 depicts a perspective view of the ladder rail grip in accordance with the present invention.

### DETAILED DESCRIPTION

The present invention relates to a ladder rail grip that is used to support a ladder against the edge of a building or a wall. The ladder rail grip is adapted to attach to the side rail with an opening provided for a rung of the ladder. The opening allows for the firm attachment of the ladder rail grip onto the side rail and preferably a strap is used to strap the rail grip into place. The opening and slot is provided for the strap as it leads through one side of the ladder rail grip. The ladder rail grip includes three sides that create a substantial triangular shape. An opening is provided at one intersection aligned for the insertion of a ladder rail grip onto the side rail of a ladder. Further a small indentation is provided on one edge of the opening to allow for the insertion of a rung of the ladder.

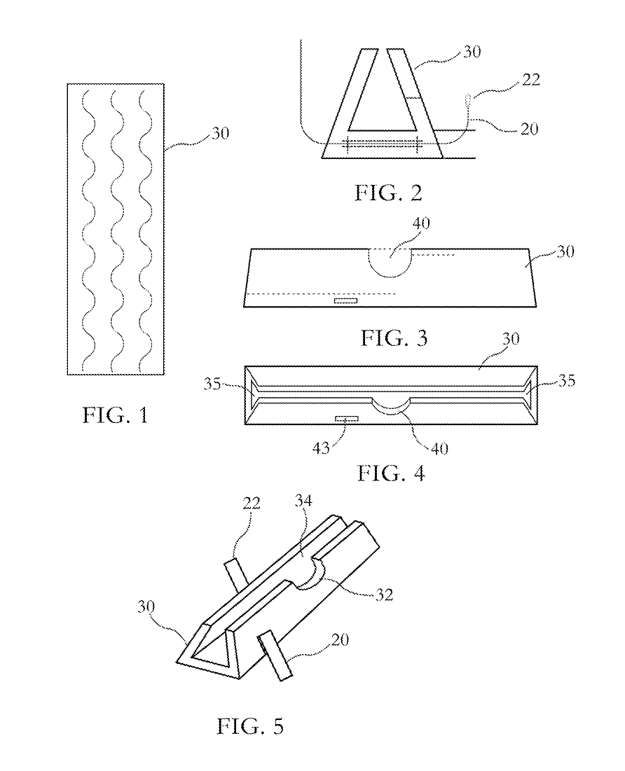

In reference to FIG. 1, a bottom view of a ladder rail grip 30 is depicted. This bottom view shows that the ladder rail grip 30 is substantially elongated providing a textured surface to prevent slippage of the ladder during use.

A sectional view of the ladder rail grip 30 is shown in FIG. 3, which depicts three sides of the ladder rail grip with an opening at the top. A strap 20 is preferably used with the ladder rail grip 30 to firmly secure the rail grip 30 around the side rail of a ladder. The strap 20 includes a buckle that slides through a slot that goes through one side of the ladder rail grip 30 as shown in FIG. 2. A side view of the ladder rail grip 30 is depicted in FIG. 3. This side view shows an indentation 40 at the midpoint of the body portion of the ladder rail grip 30. This indentation 40 accommodates for the insertion of a rung of the ladder once the rail grip 30 is placed onto the side rail of a ladder. An opening 35 is shown in the top view of FIG. 4. This opening 35 extends along the length of the ladder rail grip 30 and allows for the user to secure the ladder rail grip 30 onto the side rail of a ladder. Slat 43 is also shown that allows for the insertion of the strap 20 as shown in FIGS. 2 and 5. FIG. 5 depicts a perspective view of the ladder rail grip 30 showing an inside surface 34 exposed that receives the side rail of a ladder. An indentation 32 is also shown in FIG. 5 that helps prevent the movement of the ladder once the ladder rail grip 30 is placed over the side rail of a ladder. The instant invention has been shown and described in what it considers to be the most practical and preferred embodiments. It is recognized, however, that departures may be made there from within the scope of the invention and that obvious modifications will occur to a person skilled in the art.

What is claimed is:

1. A ladder rail grip for placement over a ladder comprising:
a. an elongated body, where the elongated body includes three sides;
b. an opening along the length of the elongated body, where the opening is adapted for placement over a side rail of the ladder;
c. a slot through the elongated body;
d. a strap extending through the slot, where the strap secures the rail grip to the ladder; and
e. a first indentation in the elongated body to accommodate a rung on the ladder.

2. The ladder rail grip according to claim 1, where the elongated body includes a textured surface.

3. The ladder rail grip according to claim 1, where the strap includes a buckle that slides through a slot that goes through one side of the ladder rail grip.

4. The ladder rail grip according to claim 1, where the first indentation is at a midpoint of the elongated body.

5. The ladder rail grip according to claim 1, further including a slat, wherein the slat allows for the insertion of the strap.

6. The ladder rail grip according to claim 1, further including a second indentation adapted to prevent movement of the ladder once the ladder rail grip is placed over the side rail of the ladder.
